(19) United States
(12) Patent Application Publication
(10) Pub. No.: US 2016/0253925 A1
(43) Pub. Date: Sep. 1, 2016

(54) Globe Structure And Fabrication System And Method

(71) Applicant: Peter S. Renner, Milwaukee, WI (US)

(72) Inventor: Peter S. Renner, Milwaukee, WI (US)

(21) Appl. No.: 14/632,427

(22) Filed: Feb. 26, 2015

(51) Int. Cl. G09B 27/08

(52) U.S. Cl. CPC G09B 27/08

(57) ABSTRACT

A series of panels and a method for assembling the panels into a spherical globe structure is provided. The panels may be of different shapes, for instance curved three-sided panels, curved five-sided panels, and curved six-sided panels. The panels may be connected to one another, or the panels may be connected to a core sphere or frame that provides added support. Once connected. the panels form a continuous spherical or globe structure. The panels may additionally include an image on an outer surface such that a continuous image is created on the structure. For instance, the structure may have an image of a map, a planet, or other spherical object. By creating a globe structure using a plurality of curved panels, the cost of production and shipment of large globes can be greatly reduced.

### FIELD OF THE INVENTION

The present invention relates generally to spherical globe structures, and more particularly, to a structure formed from panels that can be attached to one another to form a large spherical structure.

### BACKGROUND OF THE INVENTION

A variety of spherical objects are known in the art to represent globe shapes. For instance, small circular globes are commonly used to teach geography from a three dimensional perspective. Common sized globes have a diameter starting at around twelve inches. Typically, these small globes are made of two curved hemispheres which are manufactured independently and later connected. One affordable way to manufacture these hemispheres is by using a sheet of cardboard, paperboard or other thick paper. The paper is then cut into a circular shape. Next, the cardboard can be cut into a number of spoke like strips with tapered triangles of paper located, between the spokes that can then be removed. The spokes are then compressed in a semi-sphere mold that bends the cardboard down into a hemisphere design. The mold may be heated to seal the spoke-like strips together to create a hemisphere. Additionally, the mold may have a textured surface to form the paper or paperboard to reflect the peaks and valleys in elevation. After two hemispheres have been created, they can then be fastened together to form a full sphere, Oftentimes, a piece of tape or metal strip is also added to cover the seam or make the attachment. The piece of tape can also further identify the equator. Alternative means can be used to connect the two hemispheres, including tape, fasteners, or other connecting devices.

An image may be coupled with the paperboard/cardboard before the hemispheres are created. For instance, an image of half of the earth may be affixed to the sheet of cardboard before the spokes are cut. The image is then pressed and sliced with the cardboard. Alternatively, the image may be coupled to the globe after the hemispheres have been created and the globe assembled. In this example, a cover sheet including the image of the earth may be glued on to provide the specifically desired design. The cover may feature a number of paper strips with a thick central portion that taper to a smaller width at each selective pole of the globe.

This allows the image to be displayed on the globe without distortion around the large circumference located at the middle point of the globe or overlap of the strips at either of the poles. Alternatively, two sheets may be printed that are of a distorted image until a machine molds the design on to each hemisphere. Once molded to the globe, the image is no longer distorted.

Although the use of cardboard/paperboard is an affordable way to manufacture a small globe, i.e., less than 20 inches in diameter, it is impractical to manufacture larger globes, e.g., globes having a diameter over 20 inches, using these types of materials that are molded into two hemispheres. Rather, more durable materials are used once a globe reaches a large size, including glass, marble, wood, plastic, metal, or plaster in order to maintain the integrity of the globe structure at this increased size. Oftentimes, large globes are made of fiberglass spheres that have triangular pieces of printed paper glued thereto. The triangular pieces are printed with the image of the globe. Along with the change in material, the size or amount of the material that is required also increases with larger sized globes. For at least these reasons, as the size of the desired globe increases, the cost exponentially increases.

The application of images to even a small globe may be difficult due to the distortion of images as they are curved to accommodate a given surface. These challenges are further complicated when positioning images on larger globes due to the larger size of the image to be displayed. This increase in size makes it easier to notice deficiencies and distortion in the image. As such, it typically becomes difficult to apply an image across an entire hemisphere.

What is therefore needed is a globe structure and fabrication system that allows a large globe to be assembled using a number of smaller pieces that can be affordably manufactured and later assembled. This will also allow the images on the separate pieces to be more readily formed or positioned on the pieces.

### SUMMARY OF THE INVENTION

According to one exemplary aspect and advantage of the present invention, in an exemplary embodiment of the invention, a globe structure is formed by a plurality of curved panels that can be attached to form a spherical shape. The panels may be made of a thermally formed plastic, and may have an image printed on the plastic prior to thermal forming, The curved panels may be connected to one another through openings in the sides of the panels. Alternatively, the curved panels may be connected to a frame. Further still, the curved panels may be connected to a core sphere. As these panels can be affordably manufactured and later assembled, the cost of creating large globes can be reduced. The cost can be further reduced by shipping the panels prior to assembly, especially for large globes that can have diameters in excess of three feet across. Again, this increases the ease with which a large globe structure can be transported.

According to another exemplary aspect of the invention, in an exemplary embodiment of the invention, the globe fabrication system includes graphic images. The curved panels and curved panels each receive one of the graphic images. For instance the curved panels may include images that are printed onto a piece of plastic before the plastic is thermally formed. This printing may be achieved using an ultra violet cured ink jet printer. Alternatively, as the outer surface of each of the panels is curved, the graphic images may be printed onto a stretchable material. The stretchable material can then be stretched across the curved surface to ensure that the image in proportionally correct when applied to the panel. In combination, the images combine to form a unitary spherical image. For instance, the graphic images may combine to form an image of a map, a planet, or any other spherical object.

According to a further exemplary aspect of the invention, in an exemplary embodiment of the invention, the panels may be made of any number of durable, lightweight, rigid materials such as plastic or aluminum. For instance, plastic panels may be created using injection molded plastic or thermally formed plastic. Alternatively, aluminum panels may be created using die-cut aluminum. Further still, an image may he printed onto a plastic and then thermally formed to a spherical shape.

The panels may be attached by a variety of different connectors such as screws, bolts, clips, adhesive, rivets, and snap-fits. Additionally, the panels may be configured to have grooves. The panels can therefore be releasably attached.

According to still a further exemplary aspect of the present invention, in an exemplary method of constructing the spherical shape a plurality of panels are manufactured. A plurality of images is then attached to the various panels. Each image is different, and the panels should then be aligned to ensure that the images are aligned. As a result, a single continuous image is created on the exterior surface of the spherical shape.

Numerous other aspects, features, and advantages of the present invention will be made apparent from the following detailed description together with the drawings figures.

### BRIEF DESCRIPTION OF THE DRAWINGS

The drawings illustrate the best mode currently contemplated of practicing the present invention.

In the drawings:

FIG. 1 illustrates a side elevation view of an exemplary embodiment of the globe fabrication system with a self-supporting spherical shape held by a mounting stand;

FIG. 2 illustrates an exploded isometric view of an exemplary embodiment of the self-supporting spherical shape constructed of five-sided and six-sided panels with two panels detached:

FIG. 3 illustrates a top isometric view of an exemplary embodiment of the outer surface of a six-sided panel as shown in FIG. 2;

FIG. 4 illustrates a bottom isometric view of an exemplary embodiment of the inner surface of a six-sided panel as shown in FIG. 2;

FIG. 5 illustrates a top isometric view of an exemplary embodiment of the outer surface of a five-sided panel as shown in FIG. 2;

FIG. 6 illustrates a bottom isometric view of an exemplary embodiment of the inner surface of a five-sided panel as shown in FIG. 2;

FIG. 7 illustrates a bottom plan view of an exemplary embodiment of the inner surface of a six-sided panel as shown in FIGS. 3 and 4:

FIG. 8 illustrates a side elevation view of an exemplary embodiment of the six-sided panel as shown in FIGS. 3 and 4;

FIG. 9 illustrates a bottom plan view of an exemplary embodiment of the inner surface of a five-sided panel as shown in FIGS. 5 and 6;

FIG. 10 illustrates a side elevation view of an exemplary embodiment of the five-sided panel as shown in FIGS. 5 and 6;

FIG. 11 illustrates an exploded isometric view of an exemplary embodiment of a spherical shape constructed of a frame with five-sided panels adhered to the frame with two panels detached;

FIG. 12 illustrates a side elevation view of an exemplary embodiment of the frame used with the spherical shape of FIG. 11;

FIG. 13a illustrates a top plan view of an exemplary embodiment of a connection node with the frame of FIG. 12;

FIG. 13b illustrates an isometric view of an exemplary embodiment of the connection node of FIG. 13a;

FIG. 14 illustrates a top plan view of an exemplary embodiment of an alternate connection node with the frame of FIG. 12;

FIG. 15 illustrates a top plan view of an exemplary embodiment of an alternate connection node with the frame of FIG. 12;

FIG. 16 illustrates an isometric view of an exemplary embodiment of the connection node of FIG. 15;

FIG. 17 illustrates an exploded isometric view of an exemplary embodiment of a spherical shape constructed of five-sided panels with one panel detached the spherical shape having a core sphere to which the panels are attached;

FIG. 18 illustrates a top plan view of an exemplary embodiment of the panel used in FIG. 17;

FIG. 19 illustrates a side elevation view of an exemplary embodiment of the panel used in FIG. 17;

FIG. 20 illustrates an exploded isometric view of an exemplary embodiment of a spherical shape constructed of three-sided panels with one panel detached;

FIG. 21 illustrates a top plan view of an exemplary embodiment of the panel used in FIG. 20;

FIG. 22 illustrates a side elevation view of an exemplary embodiment of the panel used in FIG. 20;

FIG. 23 illustrates an exploded isometric view of an exemplary embodiment of a spherical shape constructed of five-sided and six-sided panels with two panels detached, the spherical shape having a core sphere to which the panels are attached;

FIG. 24 illustrates a top plan view of an exemplary embodiment of the six-sided panel used in FIG. 23;

FIG. 25 illustrates a side elevation view of an exemplary embodiment of the six-sided panel used in FIG. 23;

FIG. 26 illustrates a top plan view of an exemplary embodiment of the five-sided panel used in FIG. 23;

FIG. 27 illustrates a side elevation view of an exemplary embodiment of the five-sided panel used in FIG. 23;

FIG. 28a illustrates an isometric view of an exemplary embodiment of a frame used with a spherical shape with four panels;

FIG. 28b illustrates a top plan view of an exemplary embodiment of the horizontal member of the frame from FIG. 28a;

FIG. 29 illustrates an exploded isometric view of an exemplary embodiment of a spherical shape using the frame shown in FIG. 28a, the spherical shape being constructed of four panels;

FIG. 30 illustrates an exploded isometric view of an exemplary embodiment of a spherical shape constructed of four panels with one panel detached, the spherical shape having a core sphere to which the panels are attached;

FIG. 31 illustrates an exploded isometric view of an exemplary embodiment of a spherical shape using a frame with one panel detached, the spherical shape being constructed of eight panels;

FIG. 32 illustrates an isometric view of an exemplary embodiment of the frame used with the spherical shape of FIG. 31;

FIG. 33 illustrates an exploded isometric view of an exemplary embodiment of a spherical shape with two panels;

FIG. 34 illustrates a top plan view of an exemplary embodiment of a frame that can be used with the spherical shape of FIG. 33;

FIG. 35 illustrates an isometric view of an exemplary embodiment of the frame from FIG. 35.

FIG. 36 illustrates an exemplary embodiment of a method of constructing a spherical shape.

### DETAILED DESCRIPTION OF THE INVENTION

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein.

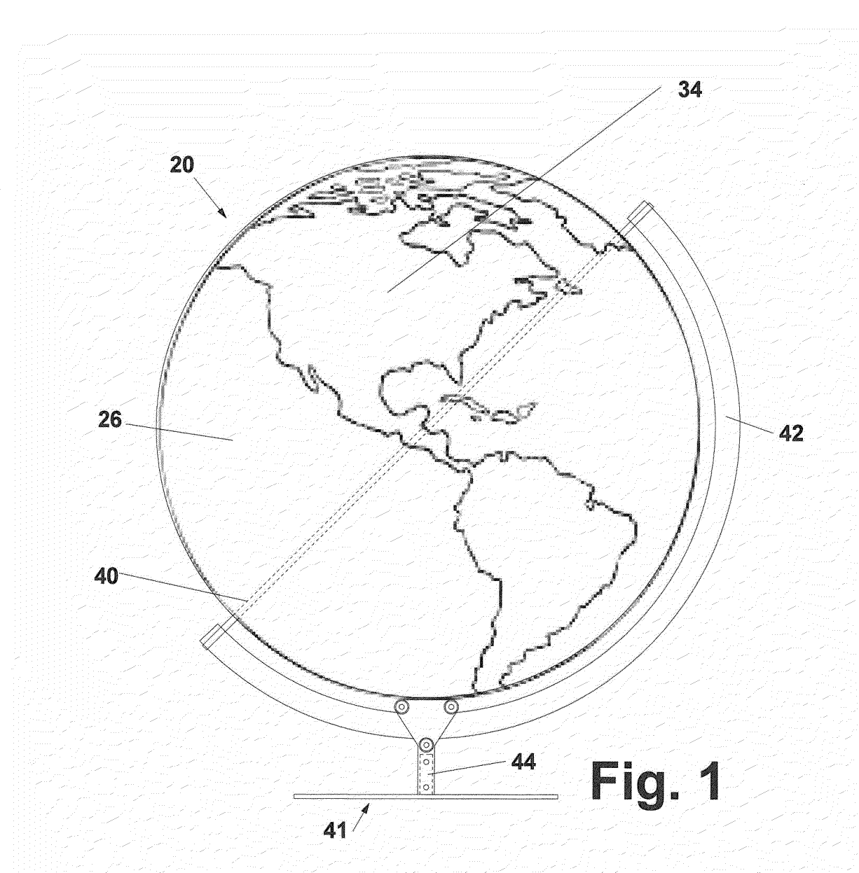

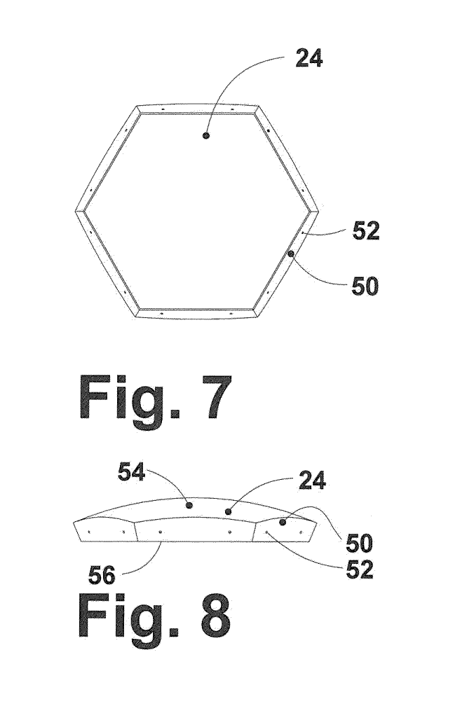

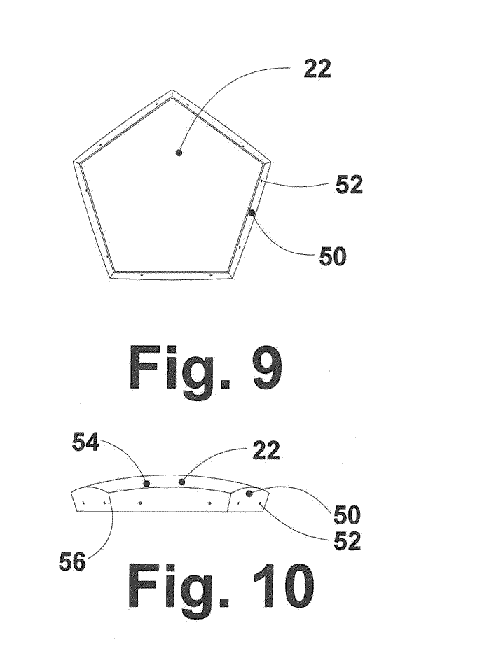

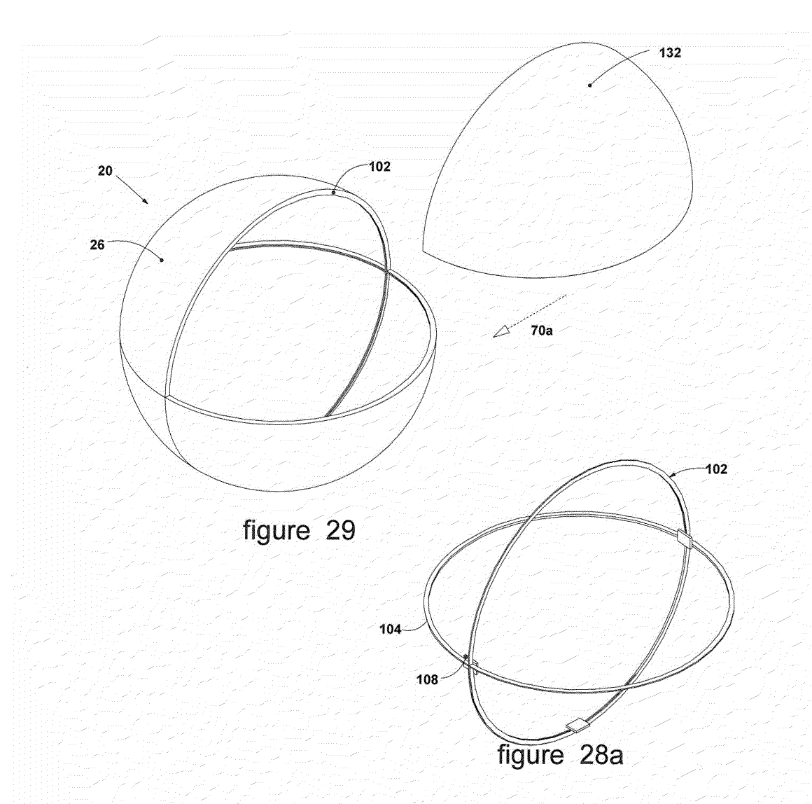

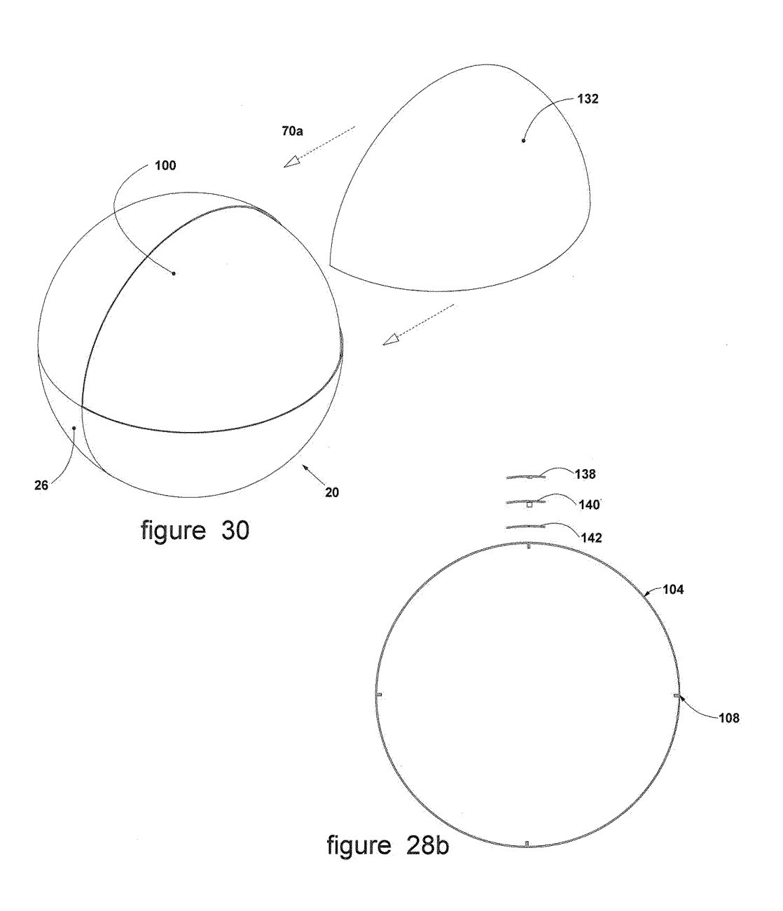

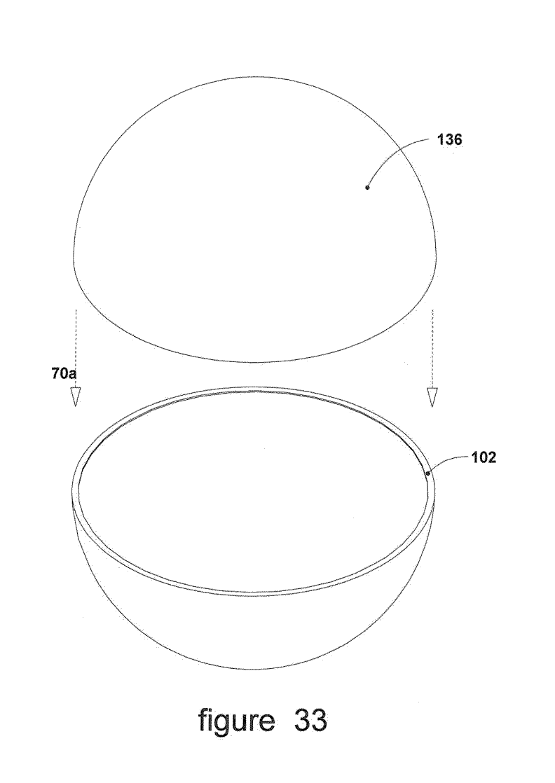

A globe fabrication system 20 is provided that includes panels of various shapes and sizes that are constructed to make spherical shapes 26 as disclosed below. For instance, globe fabrication systems 20 with three-sided panels 130, five-sided panels 22, and six-sided panels 24 are illustrated in FIGS. 1-27. Additionally, globe fabrication systems 20 with larger panels may be assembled as shown in FIGS. 28a-35. Any of these panel shapes can be used together to create a spherical shape 26. By using these curved panels and connection systems described below, large spherical shapes 26 can be created, for instance spherical shapes 26 with diameters of 36 inches, 60 inches, or 72 inches or larger. Additionally, smaller spherical shapes 26 can also be constructed.

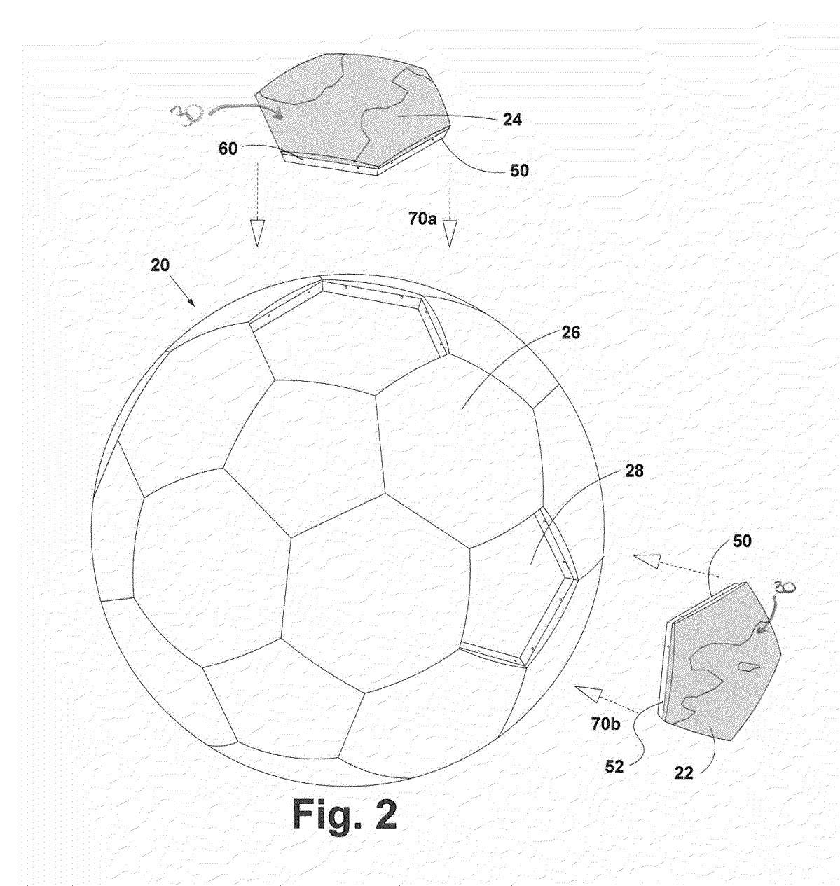

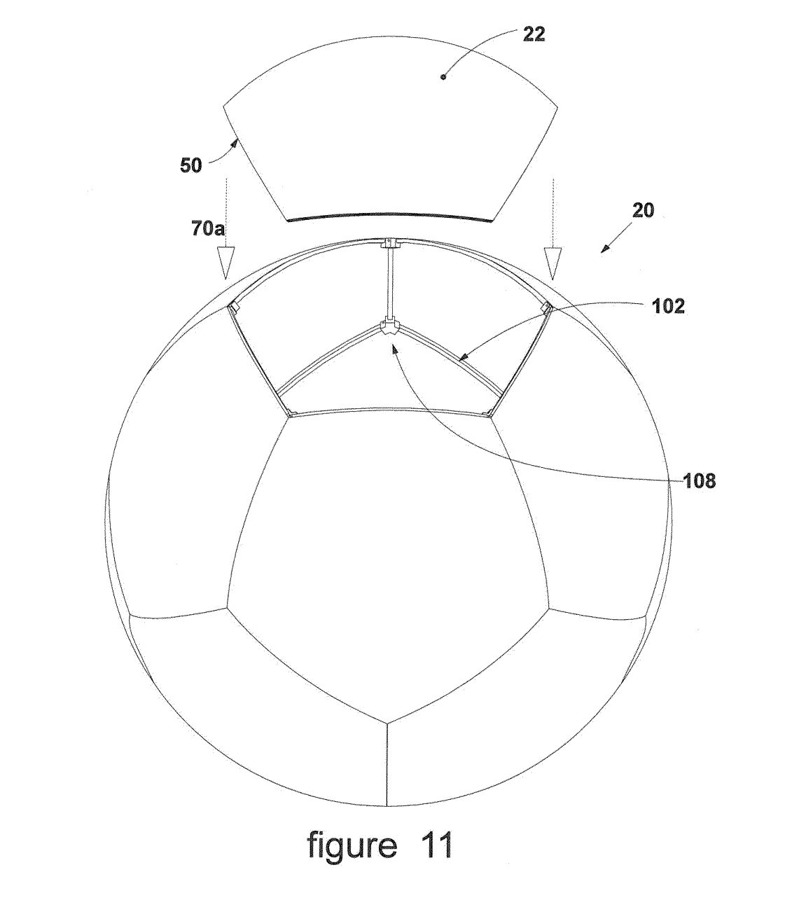

Furthermore, a number of connection systems are shown. For instance, FIGS. 2-10 and 20-22 show panels with sloped sides 50 with openings 52 such that the panels themselves form a spherical shape 26 that is self supporting. Alternatively, as shown in FIGS. 11-16 and 28a-35, various frames 102 can be used with panels to assemble the spherical shape 26. For instance, frames 102 can be constructed using support bars 104 and connection nodes 108 as will be described below. The frames 102 would then he capable of accepting various shaped panels to create the spherical shape 26. Further still, a core sphere 100 can be constructed of various materials, such as a fiberglass plastic, to which the panels can then be attached. Any of the panel configurations can be used with any of the connection systems disclosed herein.

With reference now to the drawing figures in which like reference numerals designate like parts throughout the disclosure, FIGS. 1-2 show a first exemplary embodiment of a globe fabrication system 20 resulting in a spherical shape 26 that is self-supporting with a unitary spherical image 34 located thereon. As illustrated in FIGS. 1-2, this embodiment of the self-supporting spherical shape 26 is made to have a diameter of approximately 36 inches using curved five-sided panels 22 and curved six-sided panels 24 which are configured to abut one another when forming the shape 26.

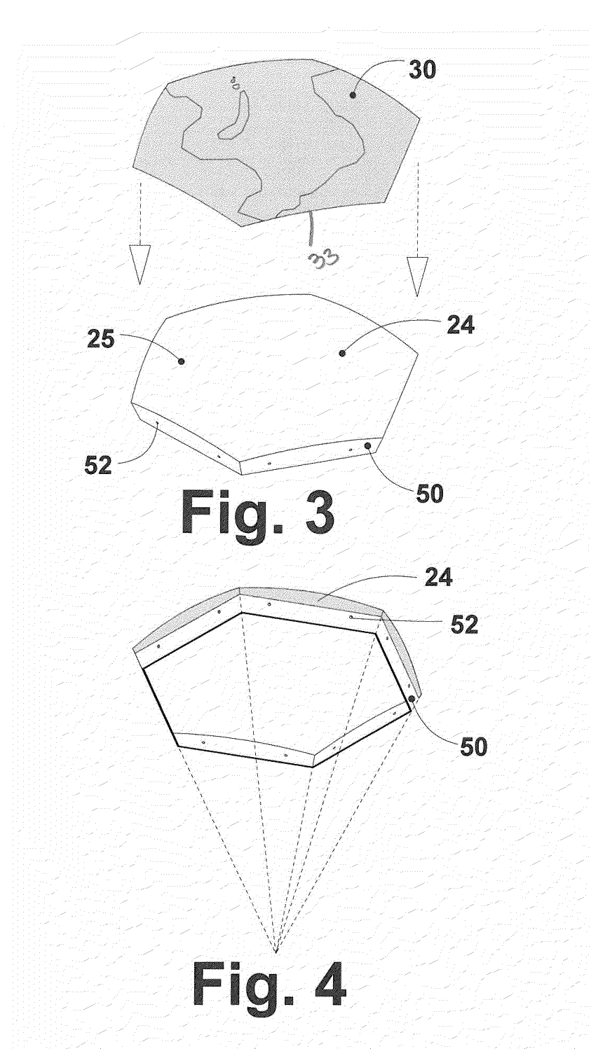

Referring now to FIG. 2, one example of a spherical shape 26 is shown that is made of curved five-sided panels 22 and curved six-sided panels 24. In this embodiment, the panels connect directly to one another. As can be seen, the lengths of each side 50 of the curved five-sided panels 22 and curved six-sided panels 24 are equivalent, and the sides 50 are substantially flat. This allows each of the panels 22, 24 to be compatible with and readily secured to one another. Further, as shown in FIGS. 3-10, the sides 50 of each panel 22 and 24 may have openings 52 formed therein and through which any suitable mechanical connectors (not shown) may be inserted. For instance, the panels 22, 24 may be attached using a variety of connectors known in the art, including nails, bolts, screws, adhesive, clips, pins, or spring clips. The sides 50 of the panels 22, 24 may also have grooves (not shown) formed therein that allow the panels 22, 24 to be releasably connected, such as in a tongue-and-groove manner. The grooves may facilitate a snap-fit connection between the panels 22, 24, or further adhesive may be used. Alternatively, rivets may be used, for instance pop rivets or plastic rivets that can be melted to heat seal the connection.

Still referring to FIG. 2, it can additionally be seen that in the exemplary embodiment each curved five-sided panel 22 is surrounded by five six-sided 24 panels. As a result, in the exemplary illustrated embodiment, a total of twenty curved six-sided panels 24 are used to form the self-supporting spherical shape 26 and twelve curved five-sided panels 22 are used for each spherical shape 26. In FIG. 2, panels 22, 24 are configured such that no interior supports or braces are required such that a hollow interior 28 exists although supports of various types can also be utilized as discussed below. Lines 70a, 70b show the path through which the panels can be attached to finalize the spherical shape 26.

Moving now to FIGS. 3, 4, 7, and 8, a curved six-sided panel 24 used with the spherical shape 26 created in FIG. 2 is illustrated. Each of the sides 50 of the panel 24 are the same length.

As can be seen, the sides 50 are substantially flat and have openings 52 through which a connector may be inserted. The sides 50 of each panel are tapered slightly inward such that they can abut other panel 22, 24 sides 50 to create a continuous and smooth spherical shape. in the exemplary embodiment, each of the sides 50 are the same length, approximately 0.198 of the total diameter of the spherical shape 26. The bottom 56 of the panel 24 is flat such that it can rest on a surface when separated from the spherical shape 26. The center portion 54 of the outer surface 25 of the panel 24 is curved away from the bottom 56, as best seen in FIG. 8. As a result, each point of the outer surface 25 of the panel is equidistant from the center of the spherical shape 26.

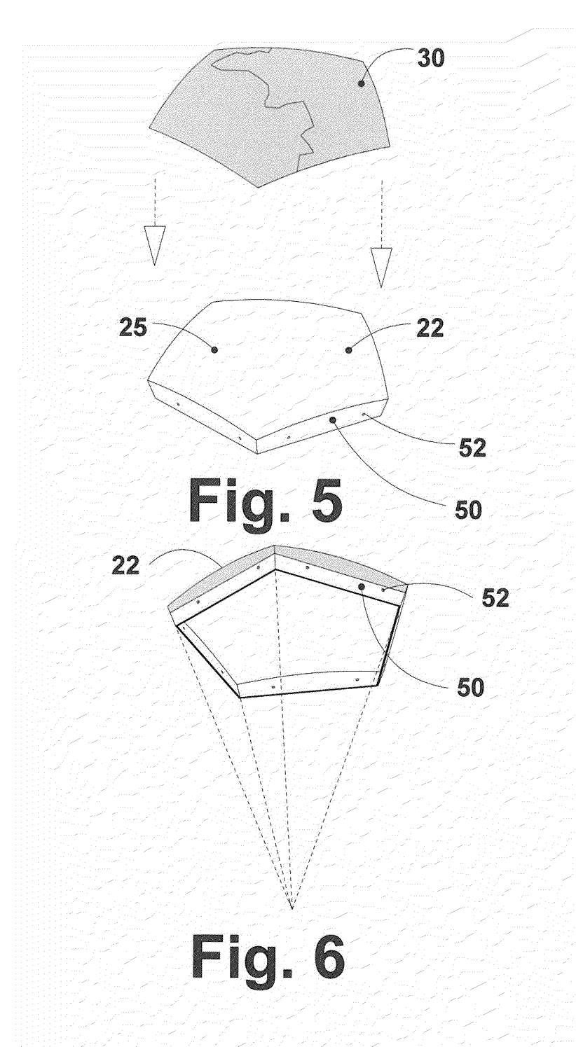

As can be seen in FIGS. 5, 6, 9, and 10, the curved five-sided panel 22 used with the spherical shape 26 shown in FIG. 2 is illustrated. Again, the sides 50 are substantially flat, slightly tapered inwardly, and of the same length. Additionally, the sides 50 have openings 52 through which a connector may be inserted. In this exemplary embodiment, similarly to the panels 24, each of the sides 50 of the panels 22 are approximately 0.198 of the total diameter of the spherical shape 26. The bottom 56 of the panel 24 is flat such that it can rest on a surface. The center portion 54 of the outer surface 25 of the panel 24 is curved away from the bottom 56, as best seen in FIG. 10,

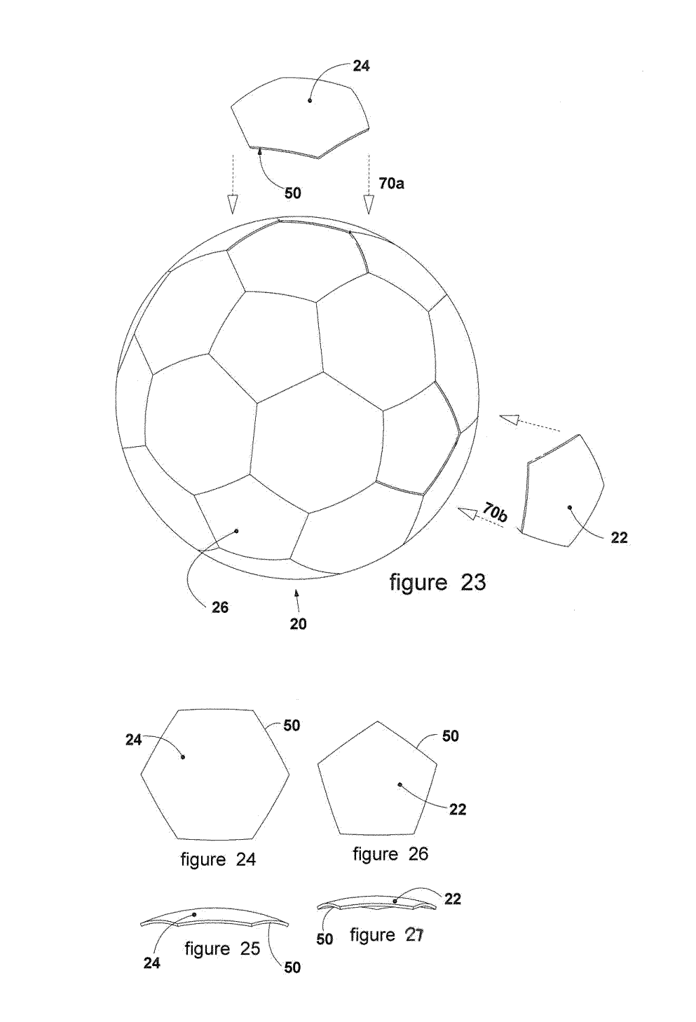

The same configuration of curved five-sided panels 22 and six-sided panels 24 as described above can be employed, using a slightly different connection system. Instead of physically connecting the panels 22, 24 together, the panels 22, 24 can be connected to a pre-assembled core sphere 100 as shown in FIG. 23. For instance, the core sphere 100 can be a fiberglass plastic ball. The core sphere 100 is created with the same diameter as the inner surface of the spherical shape 26 formed by the curved five-sided 22 and curved six-sided 24 panels. The curved five-sided 22 and six-sided 24 panels are then mounted about the core sphere 100 as shown by lines 70a, 70b. The panels 22, 24 may be glued to the core sphere 100 or affixed in any other way as known in the art.

FIGS. 24-27 illustrate the curved five-sided panels 22 and the curved six-sided panels 24 of the spherical shape 26. Because the panels 22, 24 are mounted directly to and supported by the core sphere 100, the panels 22, 24 may be thinner with smaller sides 50 that need not contain openings 52 to secure the panels 22,24 to one another. Therefore, although the sides 50 of the panels 22. 24 are not physically connected to one another, they will abut one another when affixed to the core sphere 100.

Turning to FIG. 11, another exemplary embodiment of a spherical shape 26 is shown that is formed of a plurality of curved five-sided panels 22. In this embodiment, the curved five sided panels 22 are assembled about a connection system that is formed as a frame 102. The frame 102 provides an interface to which the curved five-sided panels 22 attach and further provides structural support for the spherical shape 26. As can best be seen in FIG. 12, the frame 102 includes a plurality of support bars 104 that interface with a connection node 108 at each end. The support bars 104 are long, narrow tubes that extend laterally and may have openings 106 at both ends. The support bars 104 are illustrated as being substantially curved to facilitate engagement and support of the panels 22, although the bars 104 can also be flattened depending on the configuration of the panels 22. As can be appreciated, the frame 102 can be disassembled and/or collapsible to improve ease of transportation.

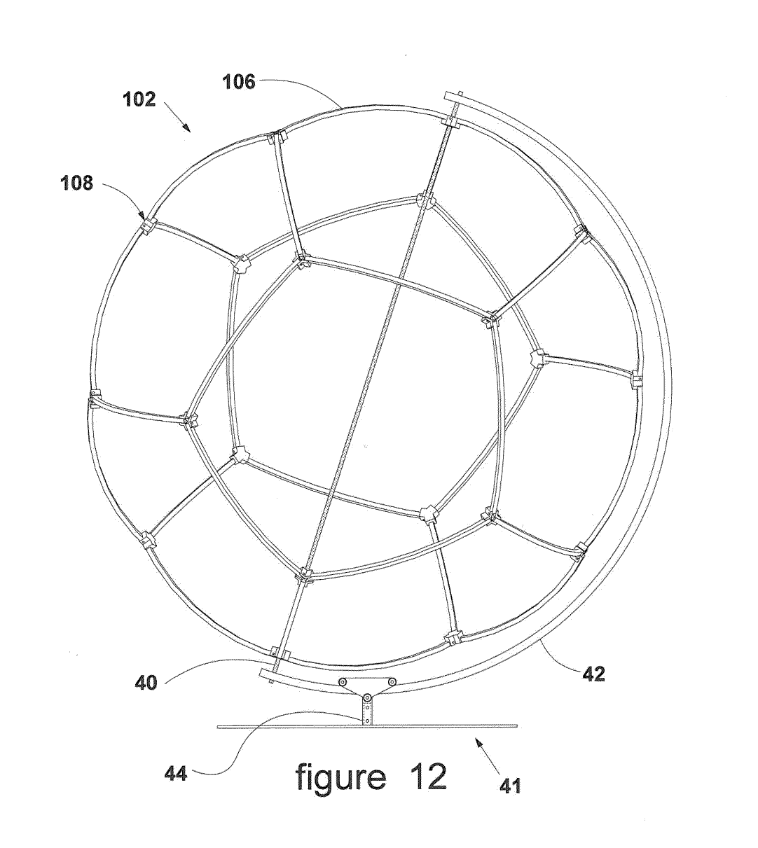

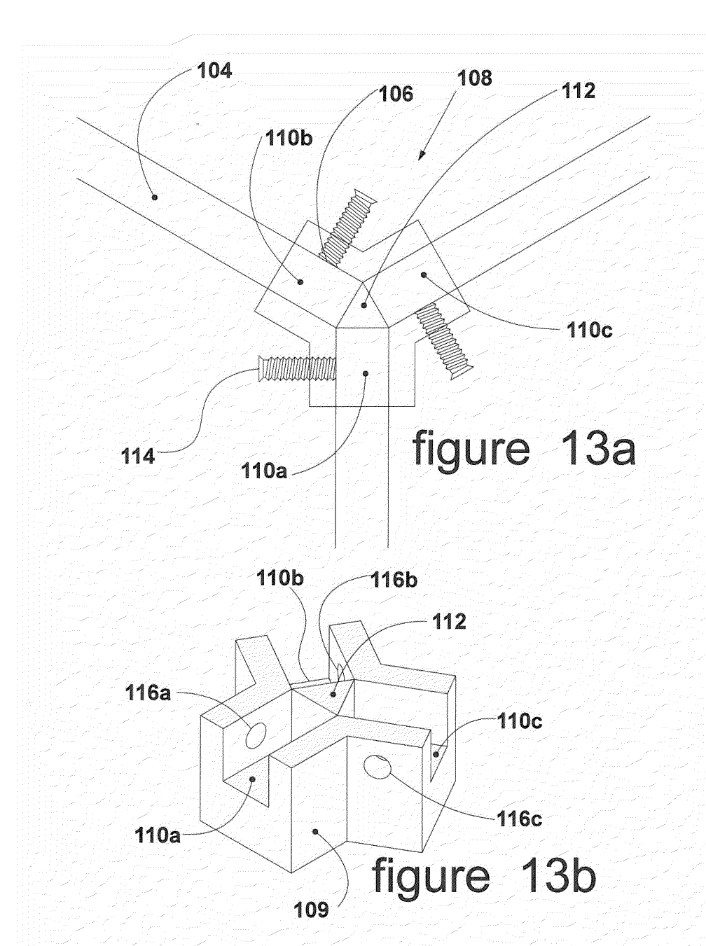

A variety of different connection node 108 configurations are available to construct the frame 102. In one exemplary embodiment, looking initially to FIGS. 13a and 13b, the connection node 108 has three channels 110a, 110b, 110c (collectively 110) that are formed substantially equidistant from each other within body 109. The channels 110 converge to a central portion 112, as shown a triangle. The support bars 104 are configured to snugly fit within the channels 110 and abut the central portion 112. Once the support bars 104 are placed within the channels 110, a bolt 114 may be inserted into an opening 116a, 116b, 116c (collectively 116) located in the side of each channel 110. The bolt 114 may additionally extend into the openings 106 in the support bars 104. Alternatively, in the event that the support bars 104 do not include openings 106, the bolt 114 can be tightened such that the support bar 104 is pressed against the opposing side of the channel 110. In either configuration, as a result of the twisting of the bolt 114, the support bars 104 are frictionally engaged with and securely connected to the connection node 108. Although bolts 114 are illustrated, the support bars 104 may be affixed to the connection node 108 using other connectors as known in the art.

Another exemplary embodiment of the connection node 108 configuration shown in FIGS. 14-16 uses a base plate 118 with three steel blocks 120a, 120b, 120c (collectively 120) positioned thereon, each with openings 122a, 122b, 122c (collectively 122) formed therein, as shown in FIG. 15. The blocks 120 may be formed with the base plate 118 or may later be attached, for instance, by welding. The blocks 120 are equidistantly located about the base plate 118. The support bars 104 are placed alongside the steel blocks 120 and secured, again using bolts 114 or other connectors as known in the art, The bolts 114 extend through the openings 122 of the blocks 120 and through the openings 106 in the support bar 104. Additionally, a nut 124 may be screwed onto the bolt 114 to secure the connection node 108 to the support bars 104. Once the support bars 104 have been secured to the connection node 108, the panels can be affixed to the frame 102 using adhesive tape 126 or other connector. FIG. 14 shows a cross section of a connection node 108 where two panels 22 are secured to a support bar 104 using the two-sided tape 126 positioned and engaged between the panels 22 and the support bar 104.

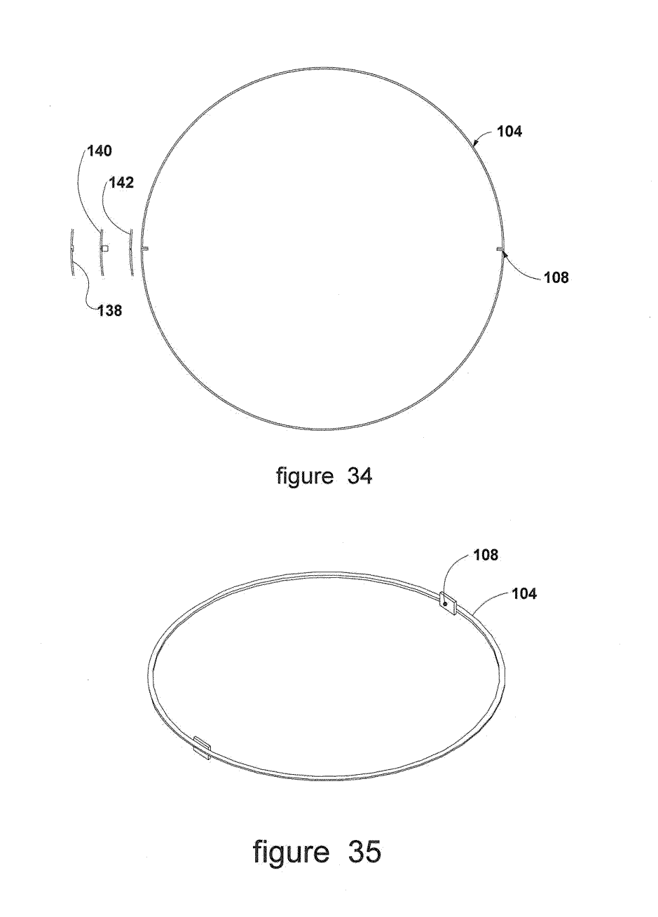

Both configurations of the connection node 108 shown in FIGS. 13a, 13b, and in FIGS. 14-16 provide three equidistantly located channels or blocks to accept three equally spaced support bars 104. However, the support bars 104 can be affixed to the connection node 108 without the use of channels or blocks and can be welded, snapped, glued, fastened or otherwise manually coupled. Furthermore, in substitution of the connection nodes 108 previously described, other joints could be used for instance lap joints 138, ring joints 140, or rabbit joints 142, as schematically illustrated in FIGS. 28b and 34. The connection node 108 can also feature additional channels or blocks at different angles therebetween to facilitate panels of different configurations from panels 22. For instance, FIG. 28a provides an alternative embodiment of the frame 102 where two connection nodes 108 are used, each being connected to four support bars 104. Each of the support bars 104 are equidistant, and thus the support bars 104 are approximately 90 degrees in comparison with the adjacent support bars 104. Further still, FIG. 32 provides yet another frame 102 design where six connection nodes 108 are used, each being connected to four support bars 104. Again, each of the four support bars 104 are equidistant, and thus are approximately 90 degrees in comparison with the adjacent support bars 104. Finally, as shown in FIGS. 34 and 35, a frame 102 may have two connection nodes 108 with two support bars 104. This frame 102 would accommodate two hemispheres 136 as shown in FIG.

33,

Next the connection system between the panels 22 and the frame 102 shown in FIG. 11 will be described. This description is exemplary and it should be noted that frames 102 configured to accept other panel configurations may be used and assembled in a similar way. Once the frame 102 has been assembled, the panels 22 may be affixed to the frame 102 in a number of ways. For instance, the frame 102 may be configured such that the panels 22 have a snap fit or flange connection. This can be implemented by using support bars 104 with a ridge or groove (not shown) that accommodate corresponding or complementary structures (not shown) located on the panels 22. Alternatively, the panels 22 may be attached using separate mechanical components, such as nails, bolts, screws, adhesive, clips, pins, spring clips, or the like. As shown, the configuration of the frame 102 allows the sides 50 of the panels 22 to lie substantially flat against one another. Further, the sides 50 of the panels 22 may lie flat against the support bars 104.

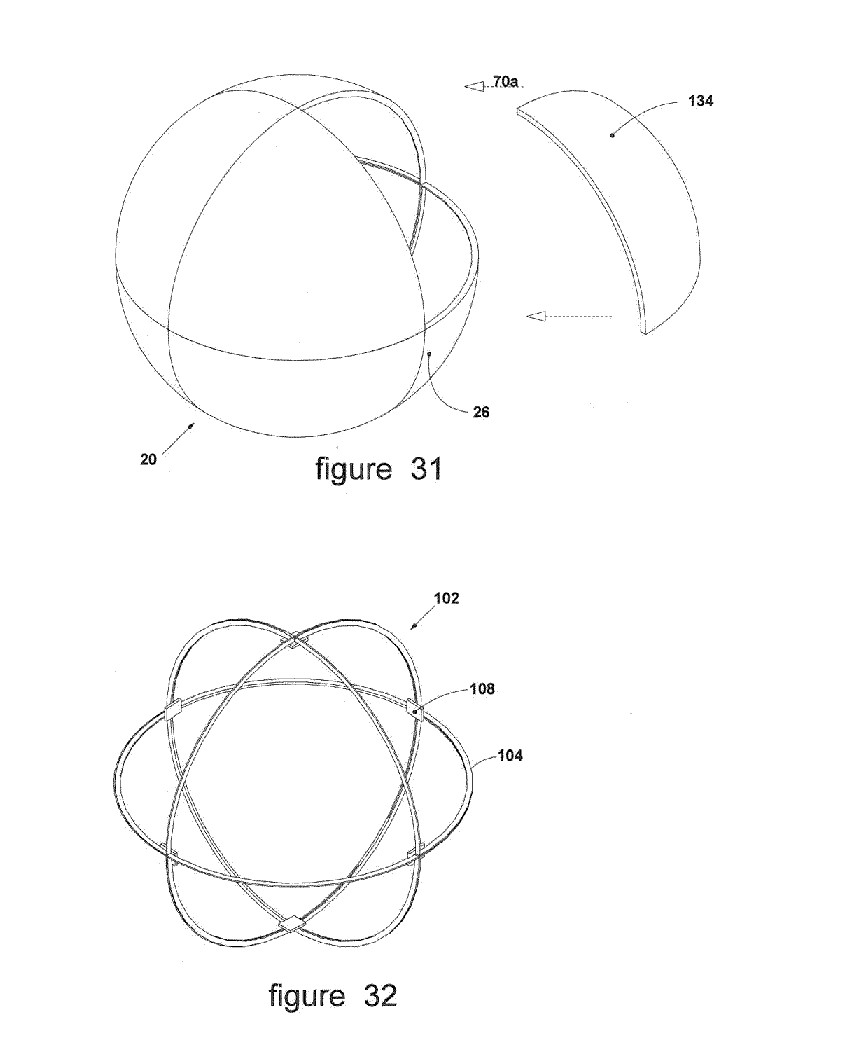

Moving now to FIGS. 28a-35 a number of semi-spherical panels may be employed with frames 102 instead of panels with multiple sides of equal length. For instance, looking initially to FIG. 29, four half hemisphere panels 132 may be connected to form the spherical shape 26. These half hemisphere panels 132 may be mounted to a frame 102, for instance with four connection nodes 108 as shown in FIG. 29. Alternatively, the half hemisphere panels 132 can be mounted to a core sphere 100 as shown in FIG. 30 in the same manner as will be described.

FIG. 31 illustrates yet another configuration of panels where quarter hemisphere panels 134 panels are used. In this embodiment the eight quarter hemispheres 134 are affixed to the frame shown in FIG. 32, although the quarter hemispheres 134 can also be connected to one another or attached to a core sphere 100.

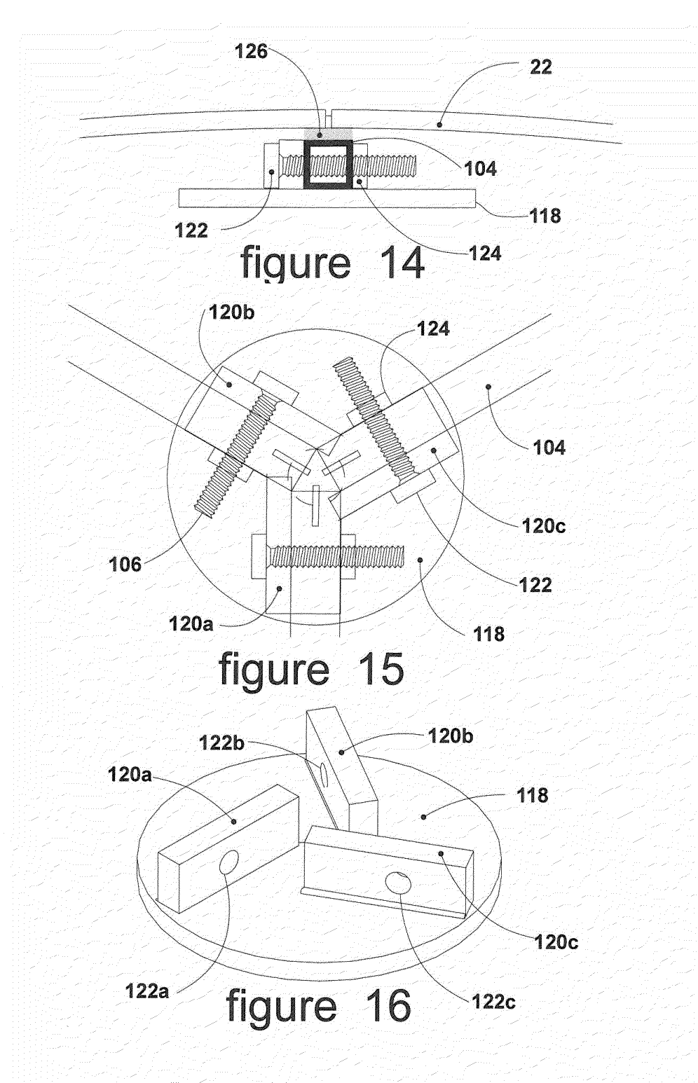

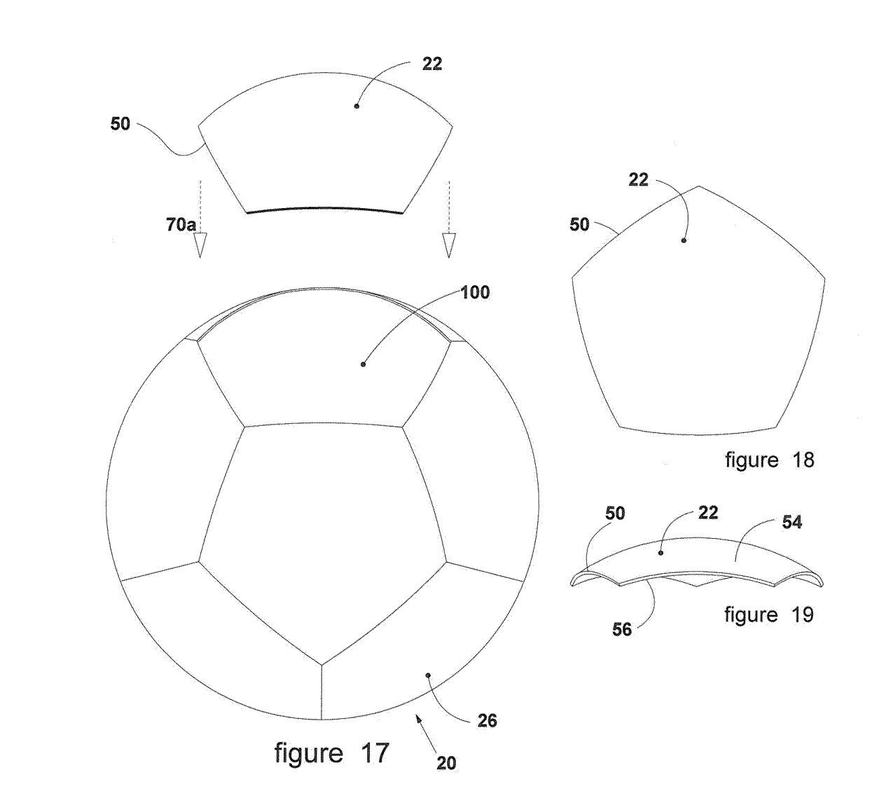

FIG. 17 shows yet another possible connection system using the curved five-sided panels 22. Instead of physically connecting the panels 22 together, the panels 22 can be connected to a pre-assembled core sphere 100. The core sphere 100 can be created with the same diameter as the inner surface of the spherical shape 26 formed by the curved five-sided panels 22. Again, the core sphere 100 can be a fiberglass plastic ball. The curved five-sided panels 22 can then be mounted about the fiberglass plastic ball. The panels 22 can be glued to the core sphere 100 or can be affixed in any other way as known in the art. FIGS. 18 and 19 show a top plan view and a side elevation view of the curved five-sided panels 22, respectively.

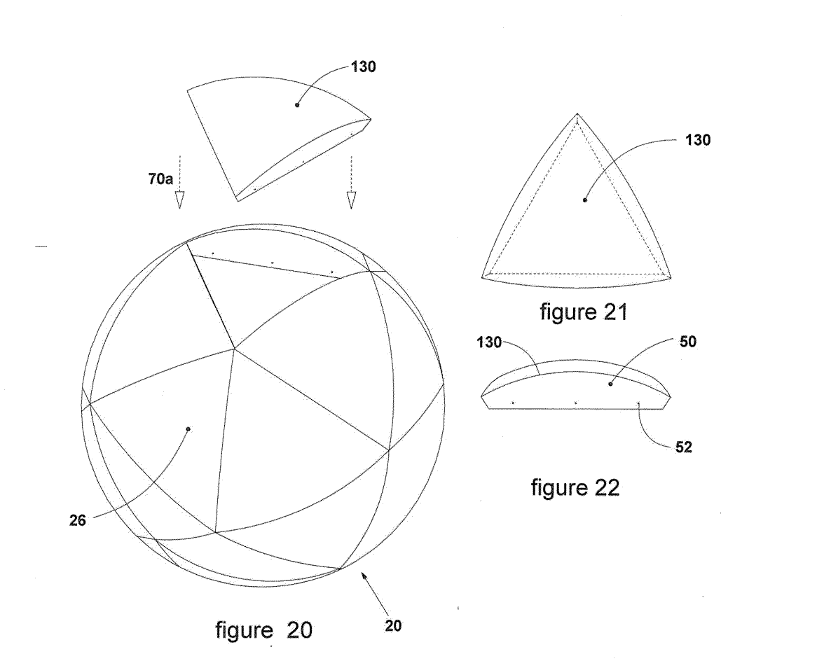

FIGS. 20-22 illustrate yet another example of the spherical shape 26 that consists of a plurality of curved three-sided panels 130 that are substantially self-supporting once connected.

Although the shape of the panels is different, the assembly of this spherical shape 26 is substantially the same as the embodiment shown in FIGS. 2-10. Again, the lengths of the each side 50 of the curved three-sided panels 130 are equivalent and the sides 50 are substantially flat and contain openings 52 through which mechanical connections may be inserted to connect the panels as described above. This allows each side 50 of each panel 130 to be compatible with one another. Again, the spherical shape 26 may have a hollow interior and be supported purely by the panels 130 without interior structure or support. Line 70a show the path on which the panels can be attached to finalize the spherical shape 26. FIGS. 21 and 22 show a top plan view and a side elevation view of the curved three-sided panels 130, respectively.

Once more, the sides 50 of each panel 130 are tapered slightly inward such that they can abut other panels 130 to create a continuous and smooth spherical shape. The bottom 56 of the panel 130 is flat such that it can rest on a surface when separated from the shape 26. The center portion 54 of the outer surface 25 of the panel 130 is curved away from the bottom 56, as best seen in FIG. 22. As a result, each point of the outer surface 25 of the panel is equidistant from the center of the spherical shape 26. Although the three-sided panel 130 configuration is only shown in FIGS. 20-22, the same panel configuration can be used with a frame or a core sphere as explained above.

The curved panels 22, 24, 130, 132, 134, and 136 can be made of any material that is durable and preferably lightweight. This allows the spherical shape 26 to be structurally sound while remaining easy to manipulate during assembly and transportation. For instance, the panels may be thermally formed as known in the art. Sheets of plastic are heated to a temperature in which the plastic is pliable and the plastic is then shaped by a mold. Additionally, the panels may be created using injection molded plastic. in this case, molds would be created for each of the different curve panel configurations, This would allow for mass production of a large quantity of panels. Similarly, the panels may be created using die cast aluminum. Again, once the dies are created, panels can be rapidly created. Further still, the panels may be made of wood, which can be cut, planed, and sanded to size. Determination of the appropriate material to use can vary on a number of factors, for instance, the desired size of the globe, the desired weight of the globe or the desired durability of the globe. Additionally, the material for the panels may be elected based on how the graphic images 30 are to be connected. Each of these options would allow the panels to be manufactured and later assembled at moderate cost.

The panels are configured specifically to result in a smooth spherical design for the resulting shape. When assembled, the impression created is not that of multiple panels that have been assembled, but rather of a continuous spherical shape 26. Although the described invention describes larger spherical designs, for instance a spherical design with at least a three foot diameter, the same inventive concept would apply to sphere of smaller sizes. A benefit of the current designs is that the separate pieces can be moved or transported and later assembled. Especially where the globe shape 26 is large in size and cannot tit through a door, this will be desirable.

Each of the curved panels 22, 24, 130, 132, 134, and 136 may include a graphic image 30 affixed to the outer surface 25 of each panel. The combination of each graphic image 30 located on the outer surface 25 of each of the panels create the unitary spherical image 34. As shown in FIG. 1, in the illustrated exemplary embodiment the unitary spherical image 34 is a map of the world. The graphic image 30 on each panel in one exemplary embodiment is formed with a printed image 30 on a section of a stretchable material, secured to the respective panel in any suitable manner, such as by an adhesive or mechanical fastener (not shown), or in a releasable manner, in order to allow individual images 30 to replaced, if necessary or desired.

Alternatively, an image 30 can be printed directly onto a plastic material that can then be thermoformed to the panel. Once the image is printed onto the plastic material, it can then be dried using an ultraviolet light. Further still, the image can be printed using an ultra violet cured ink jet printer. The plastic is then heated to a high temperature, for instance 300 degrees Fahrenheit at which point it would be formed to the panel.

The image 30 may be applied to the stretchable material in a distorted manner such that when the material 33 is stretched, the image 30 thereon is shifted into the configuration desired for an accurate representation of the unitary image 34 on the shape 26. Any spherical image could also be used, for instance the earth, the moon, planets, balls of various types, and the like. Other customizable options would also be available, for instance an earth with specific locations identified, for instance every location of a given company. In another exemplary embodiment, each panel would not receive a separate image, but rather the images 30 can be attached to one or more of the panels after the spherical shape 26 is assembled. For instance, two sheets of material 33, one including an image 30 for each hemisphere, can be affixed to the halves of the spherical shape 26 after assembly.

The spherical shape 26 may include a stand 41 as seen in FIG. 1 and 12 that displays the spherical shape 26. As shown in the illustrated exemplary embodiment, the stand 41 includes a rod 40 extending through its diameter. The rod 40 may be located at an angle to mimic the tilt of the world on its axis. The rod 40 is connected at each end to a bracket 42, more specifically a c-shaped bracket 42 that holds the rod 40 and spherical shape 26 thereon. The c-shaped bracket 42 is connected opposite the rod 40 to a base 44 that contacts the floor, desk, or other supporting surface on which the stand 41 rests. The spherical shape 26 can spin about the rod 40 to allow examination of the entire surface of the spherical shape 26. In alternative configurations, the spherical shape 26 can also be hung from a ceiling or held in place using other mounts or holders.

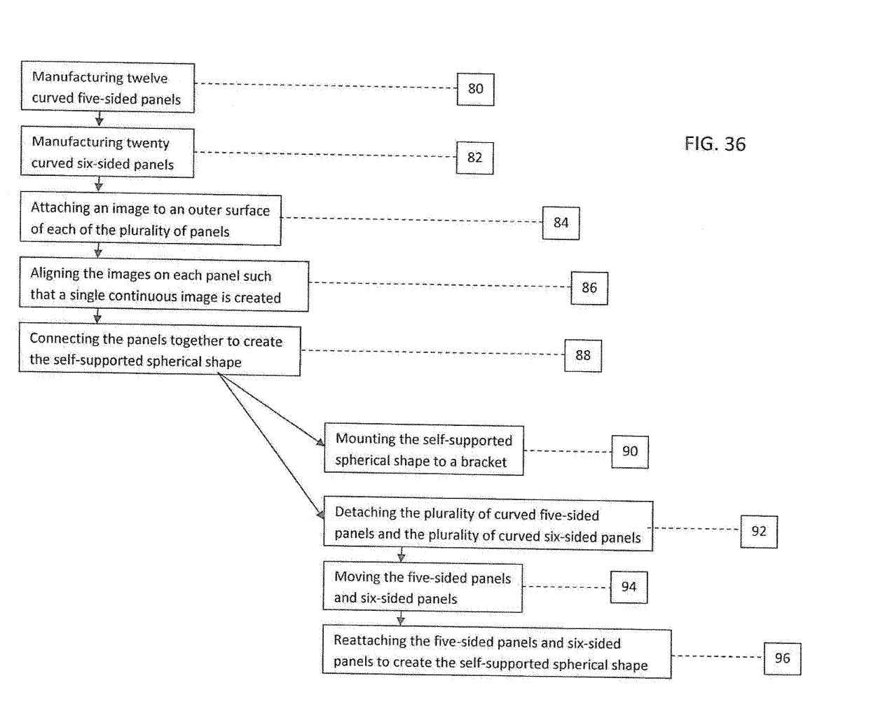

Moving to FIG. 36, a method of constructing a self-supported spherical shape is provided. First, a plurality of curved panels is manufactured in step 80. Next, an image is then attached to each of the plurality of panels in step 82. For instance, the image may be attached to the panels using an ultra violet cured ink jet printer 92. When attaching the images to the panels, the images are positioned to be aligned on each panel such that a single continuous image can be created in the resulting spherical shape in step 84. The panels are then connected together to create the self-supported spherical shape in step 86 either by connecting the panels directly to one another, to a supporting core 90 or frame 88, or any combination thereof.

After assembly, the panels can also be detached from one another in step 92. Once detached, the panels can easily be moved in step 94. The panels can then he reassembled to recreate the self-supported spherical shape where desired in step 96. Various other embodiments of the present invention are contemplated as being within the scope of the tiled claims particularly pointing out and distinctly claiming the subject matter regarded as the invention.

We claim:

1. A globe fabrication system comprising:
a plurality of curved panels; and
a plurality of graphics that are positioned on the plurality of panels;
wherein the plurality of curved panels form a spherical shape when assembled with one another.

2. The globe fabrication system of claim 1, wherein the plurality of graphics are printed.

3. The globe fabrication system of claim 2, wherein the plurality of graphics are printed on material affixed to the panels.

4. The globe fabrication system of claim 1, wherein the curved panels are each made of a plastic that is thermally formed.

5. The globe fabrication system of claim 3, further comprising a frame comprising:
a plurality of connection nodes; and
a plurality of bars connected to the nodes;
wherein the plurality of curved panels are connected to the frame to form the spherical shape.

6. The globe fabrication system of claim 3, further comprising a core sphere, wherein the plurality of curved panels are secured to the core sphere to form the spherical shape.

7. The globe fabrication system of claim 6, wherein the core sphere is a fiberglass plastic ball.

8. The globe fabrication system of claim 3, wherein the curved panels are five-sided panels.

9. The globe fabrication system of claim 3, wherein the curved panels are five-sided curved panels and six-sided curved panels.

10. The globe fabrication system of claim 3, wherein the curved panels are hemispheres.

11. The globe fabrication system of claim 3, wherein the curved panels are semi-hemispheres.

12. The globe fabrication system of claim 3, wherein the curved panels are quarter-hemispheres.

13. A globe fabrication system comprising:
a plurality of curved panels, each panel having a plurality of flat side edges of equidistant length;
wherein the plurality of panels are connected to one another by abutting the flat side edges into engagement to form a spherical shape.

14. The globe fabrication system of claim 13, further comprising a plurality of graphic images mounted to the spherical shape.

15. The globe fabrication system of claim 13, wherein the side edges each include a plurality of openings, and further comprising connector releasably inserted within aligned pairs or openings in the abutting side edges.

16. The globe fabrication system of claim 14, wherein the plurality of curved panels is made of a material selected from the group consisting of plastic and aluminum.

17. A method of constructing a self-supported spherical shape comprising:
manufacturing a plurality of curved panels;
attaching an image to each of the plurality of panels;
aligning the images on each panel such that a single continuous image is created; and
connecting the panels together to create the self-supported spherical shape.

18. The method of claim 17, wherein the step of attaching an image to each of the plurality of panels comprises printing the image on the panel.

19. The method of claim 17, further comprising the step of connecting the panels using a frame.

20. The method of claim 17, further comprising the step of connecting the panels to a core sphere.
